(19) United States
(12) Patent Application Publication
(10) Pub. No.: US 2012/0136891 A1
(43) Pub. Date: May 31, 2012

(54) Systems and Methods for Facilitating Efficient Treatment of Inter-network Communications Transmissions

(75) Inventors: Ian Neale, Winnetka, IL (US); Surendra Saboo, Winnetka, IL (US); Sonit Mahey, Naperville, IL (US)

(73) Assignee: Neutral Tandem, Inc., Chicago, IL (US)

(21) Appl. No.: 13/097,047

(22) Filed: Apr. 28, 2011

Related U.S. Application Data
(60) Provisional application No. 61/418,403, filed on Nov. 30, 2010.

(51) Int. Cl. G06F 17/30

(52) U.S. Cl. 707/769; 707/E17.014

(57) ABSTRACT

Systems and methods for facilitating treatment of a communications transmission received by a receiving network and intended for a destination network by leveraging data associated with the destination network, service provider, or device within the network. A system comprises a server module capable of communicating with the receiving network and a database registry module in communication with the server module. The database registry module contains data relating to a plurality of networks and devices associated with the plurality of networks, including the destination network. The server module is capable of receiving a query associated with the communications transmission from the receiving network. In response to the query, the server module searches the database registry module for data indicative of a network point having direct access to the destination network. The server module sends the indicative data to the receiving network for treatment of the communications transmission.

### CROSS-REFERENCE TO RELATED APPLICATION

This application claims priority from U.S. Provisional Patent Application Ser. No. 61/418403, filed Nov. 30, 2010, which is incorporated herein by reference in its entirety.

### TECHNICAL FIELD

The invention relates to communications systems, such as telecommunications systems, and more particularly, to communications systems that facilitate efficient treatment of inter-network communications transmissions, such as, for example, a telecommunications transmission between an international service provider network and a domestic service provider network.

### BACKGROUND OF THE INVENTION

Perhaps one of the most critical network infrastructure problems facing network service providers is efficient connection between various networks and switches. This is particularly a problem in telecommunications applications where telecommunications transmissions such as telephone calls must be transferred between and over different networks and switches to facilitate routing of the telephone calls. In many instances, such phone calls are inefficiently transferred between various networks with limited or no control over “downstream” routing in an effort to ultimately route the call to the destination network. Such inefficient routing ultimately increases costs and lowers Quality of Service (QoS) for the initiating or transferring network carrier.

While some systems do exist to alleviate many of the concerns with inefficient routing and provide platforms for leveraging business relationships with other carriers and network service providers through connectivity management, there is still room for improvement. Service provider based inter-network routing, which leverages service provider network identification before a call is routed, would, among other things, increase efficiency and QoS, and reduce costs associated with routing. In telecommunications applications, many geographic regions employ complex and dynamic numbering schemes which inhibit the ability to route based on identity of service providers. Number portability in many regions further inhibits this ability. In the case of international carriers or service providers, these issues further complicate, if not render impossible based on present practices, the ability to efficiently and more intelligently treat call traffic destined to a domestic network.

The invention described and claimed herein addresses, among other things, problems with respect to inter-network routing, particularly as applied to telecommunication transmissions.

### SUMMARY OF THE INVENTION

The invention provides systems and methods for facilitating treatment of a communications transmission received by a receiving network and intended for a destination network by leveraging data associated with the destination network, a service provider, or a device within the destination network.

According to a particular aspect, a system is provided for facilitating treatment of a communications transmission received by a receiving network and intended for a destination network. The system comprises a server module capable of communicating with the receiving network and a database registry module in communication with the server module. The database registry module contains data relating to a plurality of networks, including the destination network. The server module is capable of receiving a query associated with the communications transmission from the receiving network. In response to the query, the server module searches the database registry module for data indicative of a network point having access to the destination network. The server module sends the indicative data to the receiving network for treatment of the communications transmission in accordance with a protocol of the receiving network so that the communications transmission can be received by the intended destination network.

According to another aspect, the communications transmission comprises a telecommunications transmission intended for a destination device associated with a telephone number.

According to another aspect, the communications transmission is intended for a destination device associated with an IP address or other identification indicia.

According to yet another aspect, and in the case of a telecommunications transmission, the data sent to the receiving network from the server module includes the telephone number and a data structure appended thereto indicative of the network point having direct access to the service network.

According to yet another aspect, the network point comprises a trunk group or is part of the destination network.

According to yet another aspect in the case of a telecommunications transmission, the server module, further in response to the query, corrects for number portability of the telephone number.

According to yet another aspect, the network point comprises an integrated network interface.

According to yet another aspect, the protocol comprises either one of sending the communications transmission to the network point or sending the communications transmission to a second network point not having direct access to the destination network but associated with a second network having a predetermined arrangement with the receiving network.

These and other aspects will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a multi-network environment in accordance with one or more principles of the invention.

FIG. 2 is a schematic diagram depicting a particular embodiment implementing systems and methods in accordance with one or more principles of the invention in an international/domestic network environment.

FIG. 3A is a schematic diagram depicting a data format in accordance with a particular aspect of the invention.

FIG. 3B is a schematic diagram depicting a particular embodiment of the data format of FIG. 3A.

FIG. 4 is a flow chart depicting steps of a method of a particular embodiment of the invention.

### DETAILED DESCRIPTION OF EXEMPLARY EMBODIMENTS OF THE INVENTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

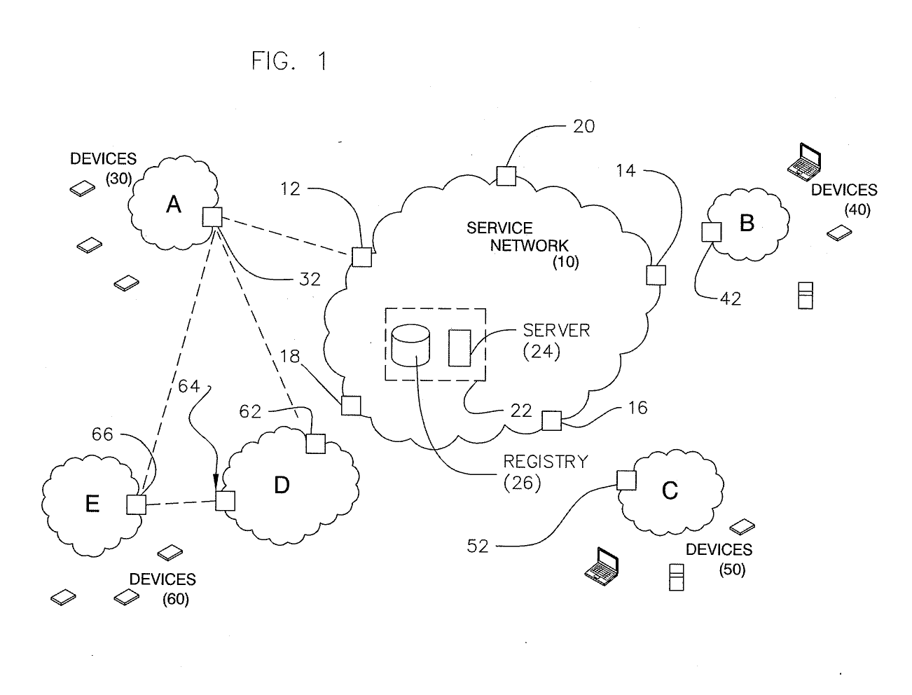

FIG. 1 is a schematic diagram of a multi-network environment in accordance with one or more principles of the invention. As shown in FIG. 1, a plurality of carrier or service networks A-E are either in direct or indirect communication with each other and with a service network 10 associated with a system 22 for facilitating treatment of inter-network communications; the system 22 will be described in more detail below. Each of the service networks A-E may have one or more respective devices 30, 40, 50, 60 associated with it via presence within the network or a service subscription relationship with one or more of the plurality of networks. For ease of illustration each of the networks are depicted schematically as separate and not overlapping in FIG. 1, but it should be understood that one or more of the networks may overlap each other in terms of geographic extent, coverage or connectivity. It should also be understood that the term device includes hardware, firmware and pure software devices, including without limitation processor-based devices such as cellular telephones, smart phones, handheld devices having data, e-mail, voice or video capability, desktop computers, laptop computers, net book computers, software having communications functionality, or the like.

Each of the networks may include one or more network points. For example, the service network 10 is schematically illustrated having network points 12, 14, 16, 18 and 20, network A is schematically illustrated having network point 32, network B is schematically illustrated having network point 42, network C is schematically illustrated having network point 52, and networks D and E are schematically illustrated having network points 62 and 66, respectively. Each network point may be any type of network point or switch known in the art, including without limitation, network access points, service control points, telecommunications tandem switches, etc.

As shown in FIG. 1, the service network 10 includes the system 22 for facilitating treatment of inter-network communications. In the schematic embodiment illustrated in FIG. 1, the system 22 facilitates transmissions amongst the plurality of networks A-E. However, it should be understood that the system 22 can be employed in an environment comprising any number of networks in numerous embodiments and configurations; FIG. 1 is limited to networks A-E merely for ease of illustration. The system 22 includes a server module 24 and a database registry module 26. The server module 24 and the database registry module 26 are schematically depicted separately from a functional standpoint, but it should be understood that these modules may be part of the same implementation or device, and may be implemented in numerous configurations of hardware, firmware or software as known to one of ordinary skill in the art. Furthermore, while the term module is employed, it is intended to cover any and all respective hardware, software or firmware implementations of a server and database registry.

Likewise, while depicted schematically as a single server or server module, computer or system, it should be understood that the terms “server,” “server module,” “registry,” “registry module” and “system” as used herein and as depicted schematically in FIG. 1 may represent more than one server module, registry module, or computer within a single system or across a plurality of systems, or other types of processor-based computers or systems. The server module 24 preferably includes at least one processor, which is a hardware device for executing software/code, particularly software stored in a memory or other computer readable medium. The processor can be any custom made or commercially available processor, a central processing unit (CPU), an auxiliary processor among several processors associated with the server module 24, a semiconductor based microprocessor (in the form of a microchip or chip set), another type of microprocessor, or generally any device for executing software code/instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

Memory can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by the processor.

The software in memory or any other computer readable medium may include one or more separate programs. The separate programs comprise ordered listings of executable instructions or code, which may include one or more code segments, for implementing logical functions. In the exemplary embodiments herein, the server application runs on a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of computer programs/code such as the server application of server module 24, and provides scheduling, input-output control, file and data management, memory management, and communication control and related services.

In the embodiment depicted in FIG. 1, the database registry module 26 is in communication with the server module 24 and contains data relating to the plurality of networks A-E and the devices 30, 40, 50, 60 associated with the plurality of networks. Again, it should be understood that the system 22, including server module 24 and the registry module 26, can be employed in an environment comprising any number of networks in numerous embodiments and configurations; FIG. 1 is limited to networks A-E merely for ease of illustration. The data contained in the registry module 26 may include, for example, service provider or carrier IDs associated with devices or service numbers, device locations, device or network capabilities, routing information, trunk IDs, integrated network interface IDs, etc. As will be described in more detail, one or more aspects of this data may be accessed and utilized to facilitate treatment of a communications transmission received by a receiving network and destined for another network.

It should be noted that the phrase communications transmission is not limited to the routing of telephone calls, but encompasses any session-oriented service. Accordingly, the phrase communications transmission is intended to cover without limitation voice, data, video and other session-oriented services. The communications transmissions are also intended to extend to IP telephony and Ethernet-based telecommunications as well. Furthermore, it should be understood that the communications transmissions contemplated herein are not merely limited to telecommunications transmissions, but may also extend to other network transmissions as well.

With reference to FIG. 1, and by way of example, a receiving network, such as service network A, receives a communications transmission from another network or a device, such as one of the devices 30, wherein the transmission is destined for a device being serviced by or present on a destination service network, such as one of the devices 60 associated with service network E. To facilitate treatment of the communications transmission, the service network E sends and the server module receives a query associated with the communications transmission. In response to the query, the server module searches the database registry module for data indicative of the service network within which the destination device is associated and a network point having direct access to the service network and sends the data to the receiving network for treatment of the communications transmission, which may be in accordance with one or more protocols of the receiving network. The protocol may include, for example, sending the communications transmission directly to the network point 32 or sending the communications transmission to a second network point 62 not having direct access to the destination service network E but associated with a second services network, services network D, the service provider of which may have a predetermined arrangement with the service provider of the receiving network E. Such predetermined arrangements may be based on business relationships, such as, for example, those established through bi-lateral agreements. The protocol may also include having the server module, or the system associated therewith depending on the configuration, send the communications transmission directly to the network point 66 on behalf of the receiving network.

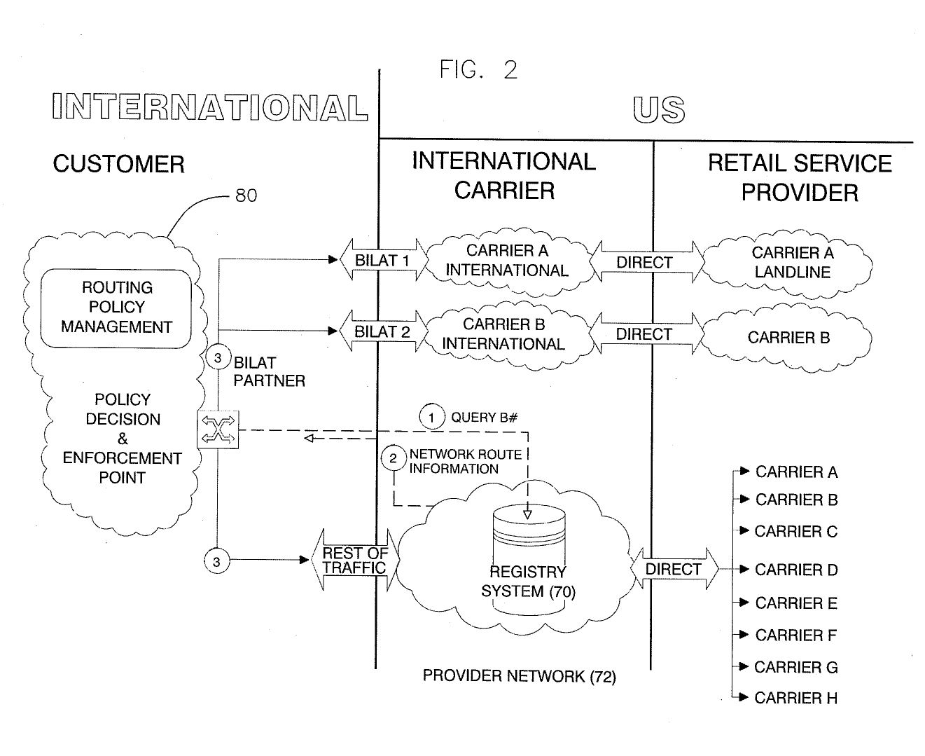

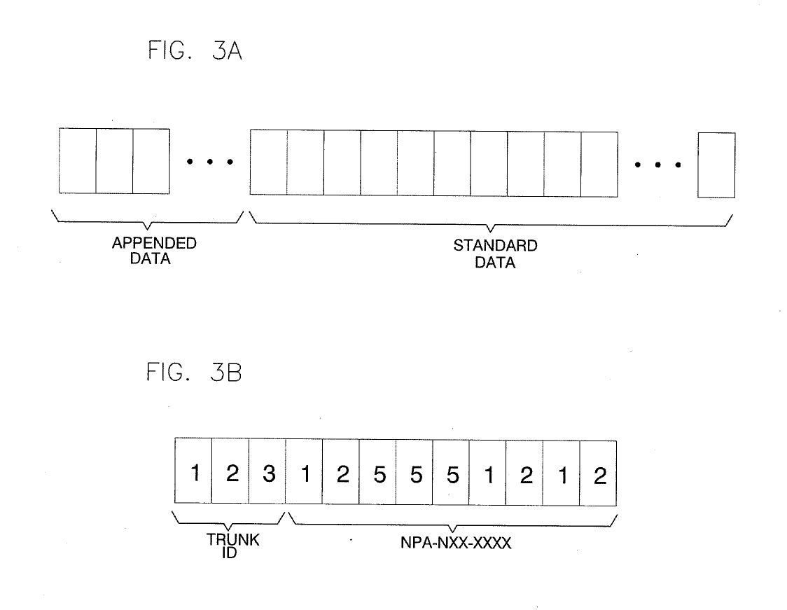

A particular embodiment of the systems and methods of the invention may be employed in an international-domestic telecommunications network environment. With reference to FIG. 2, a system 70, which is depicted as an integrated system comprising a registry/server within a service provider network 72, can be leveraged to facilitate treatment of call traffic destined for a domestic network by an international customer of the service provider. An international customer network 80 as a receiving network receives a telecommunications transmission in the form of a telephone call which, based on the called telephone number, is destined for a US network. The international customer leverages the system 70 by sending a query to the system 70 as indicated in FIG. 2 as step 1. In response to the query, the system searches the registry for data relating to network routing, such as, for example, data indicative of the US service network within which the destination device associated with the called number is located or a network point having direct access to the US service network. The data is sent back to the international customer network as indicated by step 2. This data can include data types and format predetermined by the international customer or the service provider of the service provider network 72. In this particular embodiment, the data includes data indicative of a network point having direct access to the US service network, such as, for example, a trunk ID or integrated network interface ID. As indicated in FIG. 3A, the data may be appended to standard data which may have been sent as part of the query. In this particular embodiment, this data is appended to the NPA-NXX-XXXX data and sent back to the international customer for processing by the international customer network 80. Because the data is appended to the called telephone number, also referred to in the case of a domestic call as the NPA-NXX-XXXX, it can be processed with minimal modifications to the standard processing by international customer network 80. As shown in FIG. 3B, data indicative of a trunk ID servicing the US service network of interest is appended to the NPA-NXX-XXXX. Preferably, the data is appended as a prefix to the NPA-NXX-XXXX. As indicated in FIG. 2 as the “Policy Decision and Enforcement Point,” the international customer utilizes the data sent from the system 70 in accordance with its predetermined routing policy/protocol management. In this embodiment, as indicated at step 3, this policy includes either sending the call to a bilateral partner as determined by the appended data, such as a trunk ID, to leverage an existing business relationship or having the call processed by the service provider network 72 to have it sent directly to the carrier associated with the NPA-NXX-XXXX, which may be amongst carriers A-H as illustrated in FIG. 2. Thus, the system allows the international customer to make informed policy management decisions that have heretofore been unavailable to it due primarily to the lack of transparency to US domestic network/device data.

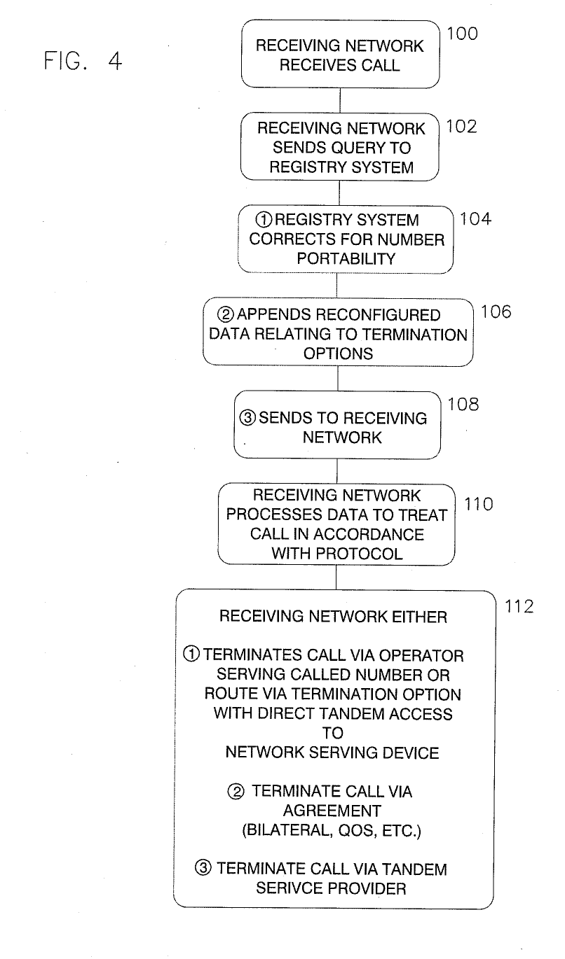

With reference to FIG. 4, a method utilizing a system in accordance with one or more principles of the invention is outlined for facilitating treatment of a telecommunications transmission received by a receiving network and intended for a destination device associated with a service network. At step 100, a receiving network receives a call having an associated NPA-NXX-XXXX. At step 102, the receiving network sends a query to the registry system, which includes a server module and a database registry module. In this embodiment, the registry system corrects for number portability at step 104, appends reconfigured data relating to termination options at step 106 and sends the data to the receiving network at step 108. At step 110, the receiving network processes the data to treat the call in accordance with its predetermined protocol. In this embodiment, an exemplary protocol is set forth at step 112, which includes either (1) terminating the call via a service provider serving the called NPA-NXX-XXXX; (2) routing the call via a termination option with direct interconnection access to the network serving the device associated with the NPA-NXX-XXXX, (3) terminating the call via an agreement with a carrier or service provider; or (4) terminate the call via a service provider associated with the registry system.

It should be noted again that the systems and methods described and contemplated herein have broad applicability to numerous types of networking environments and are not strictly limited to telecommunications applications described herein. While one or more specific embodiments have been illustrated and described in connection with the invention, it is understood that the invention should not be limited to any single embodiment, but rather construed in breadth and scope in accordance with recitation of the appended claims.

What is claimed is:

1. A system for facilitating treatment of a communications transmission received by a receiving network and intended for a destination network, the system comprising:
a server module capable of communicating with the receiving network; and
a database registry module in communication with the server module and containing data relating to a plurality of networks, including the destination network;
wherein the server module is capable of receiving a query associated with the communications transmission from the receiving network, and in response to the query, searching the database registry module for data indicative of a network point having access to the destination network, and sending the indicative data to the receiving network to facilitate treatment of the communications transmission in accordance with a protocol of the receiving network so that the communications transmission can be received by the intended destination network.

2. The system of claim 1, wherein the communications transmission is intended for a destination device associated with an IP address.

3. The system of claim 1, wherein the communications transmission comprises a telecommunications transmission intended for a destination device associated with a telephone number.

4. The system of claim 3, wherein the data sent to the receiving network from the server module includes the telephone number and a data structure appended thereto indicative of the network point having access to the destination network.

5. The system of claim 4, wherein the network point comprises a trunk group.

6. The system of claim 4, wherein the network point is part of the destination network.

7. The system of claim 3, wherein the server module, further in response to the query, corrects for number portability of the telephone number.

8. The system of claim 1, wherein the network point comprises an integrated network interface.

9. The system of claim 1, wherein the network point has direct access to the destination network, and wherein the protocol comprises either one of sending the communications transmission to the network point or sending the communications transmission to a second network point not having direct access to the destination network but associated with a second network having a predetermined arrangement with the receiving network.

10. The system of claim 1, wherein the system sends the communications transmission to the network point on behalf of the receiving network.

11. The system of claim 9, wherein the network point is part of the destination network.

12. The system of claim 1, wherein the network point is part of the destination network.

13. A system for facilitating treatment of a communications transmission received by a receiving network and intended for a destination device associated with a service network, the system comprising:
a server module capable of communicating with the receiving network; and
a database registry module in communication with the server module and containing data relating to a plurality of networks and devices associated with the plurality of networks, including the service network and the destination device;
wherein the server module is capable of receiving a query associated with the communications transmission from the receiving network, and in response to the query, searching the database registry module for data indicative of the service network within which the destination device is associated and a network point having access to the service network, and sending the indicative data to the receiving network for treatment of the communications transmission in accordance with a protocol of the receiving network so that the communications transmission can be received by the destination device.

14. The system of claim 13, wherein the communications transmission comprises a telecommunications transmission intended for a destination device associated with a telephone number.

15. The system of claim 14, wherein the data sent to the receiving network from the server module includes the telephone number and a data structure appended thereto indicative of the network point having access to the service network.

16. The system of claim 15, wherein the network point comprises a trunk group.

17. The system of claim 15, wherein the network point is part of the service network.

18. The system of claim 14, wherein the server module, further in response to the query, corrects for number portability of the telephone number.

19. The system of claim 13, wherein the network point comprises an integrated network interface.

20. The system of claim 13, wherein the network point has direct access to the service network, and wherein the protocol comprises either one of sending the communications transmission to the network point or sending the communications transmission to a second network point not having direct access to the service network but associated with a second services network having a predetermined arrangement with the receiving network.

21. The system of claim 19, wherein the network point is part of the service network.

22. The system of claim 13, wherein the network point is part of the service network.

23. The system of claim 13, wherein the server module comprises a logical server.

24. The system of claim 13, wherein the server module comprises processor-based hardware.

25. The system of claim 13, wherein the server module comprises software.

26. The system of claim 13, wherein the server module and the database registry module reside within a single hardware component.

27. The system of claim 13, wherein the destination device comprises a software device.

28. The system of claim 13, wherein the destination device comprises a hardware device.

29. The system of claim 13, wherein the destination device comprises a firmware device.

30. The system of claim 13, wherein the communications transmission comprises a service session.

31. The system of claim 13, wherein the communications transmission comprises a voice transmission.

32. The system of claim 13, wherein the communications transmission comprises a video transmission.

33. The system of claim 13, wherein the communications transmission comprises a service session including voice transmission.

34. The system of claim 13, wherein the communications transmission comprises a service session including video transmission.

35. A computer program product stored on a computer-readable medium, the computer program product having computer-executable code instructions which are executable on a computer server to facilitate treatment of a communications transmission received by a receiving network and intended for a destination network, the computer-executable code instructions comprising:
first code instructions for receiving a query from the receiving network;
second code instructions for searching a database registry containing data relating to a plurality of networks, including the destination network, for data indicative of a network point having access to the destination network; and
third code instructions for sending the data indicative of a network point having access to the destination network to the receiving network to facilitate treatment of the communications transmission in accordance with a protocol of the receiving network so that the communications transmission can be received by the intended destination network.

36. The computer program product of claim 33, wherein the query includes an NPA-NXX-XXXX and the data indicative of the network point having access to the destination network is appended thereto and sent to the receiving network.
